(19) United States
(12) Patent Application Publication
(10) Pub. No.: US 2011/0270778 A1
(43) Pub. Date: Nov. 3, 2011

(54) SHARING INVESTMENT INFORMATION VIA A SOCIAL NETWORKING WEBSITE

(76) Inventor: Arghya Mondal, Jersey City, NJ (US)

(21) Appl. No.: 12/770,889

(22) Filed: Apr. 30, 2010

(51) Int. Cl. G06Q 40/00; G06Q 99/00

(52) U.S. Cl. 705/36 R; 705/319

(57) ABSTRACT

An application for sharing investment information through social networking websites, such as Facebook®, is disclosed. The application can retrieve investment information from a financial institution via the internet and then select only information that a user wishes to share so sensitive or personal information is removed prior to sharing the investment information. The application can provide access to the investment information through the social networking website by individuals selected by the user. The user can require a fee or other consideration for others prior to providing access to the investment information.

### FIELD

This application relates generally to sharing investment information, and particularly to investment information sharing via the internet.

### BACKGROUND

In the past, individual investors needed a broker to buy and sell different financial instruments and securities, keeping many middle-class and even financially successful individuals from investing through a stock market, bond market, or other financial exchanges. With the advent of the internet and online investing and portfolio management, millions of people throughout the world are able to invest in a variety of stocks, bonds, mutual funds, and other investment vehicles, and invest through a number of different exchanges and markets.

Successful investors often wish to share or sell access to their investment strategies. Some investors also enjoy bragging about their investment successes, much the same that hunters and fishermen enjoy reliving and retelling stories of particularly successful endeavors. However, it is generally rude and ungraceful for an individual to disclose the net value of an investment or portfolio. As such, it is very difficult to verify that any particular investor is successful or is truthfully indicating their actual success without revealing portfolio statement and the quantity/value information on those statements to prove the veracity of a successful investment.

Because of the verification problems of proving a successful investor, it is difficult for the average investor to know which advice to seek or follow in their own personal investment strategies. This difficulty has lead to many people selling or sharing investment information and advice that may or may not be valuable or based on past successes, or may not be valuable for other reasons. Furthermore, it is often desirable for an investor to confide in or follow the advice of close friends or acquaintances, with whom a certain level of trust and rapport has already been established. However, friends and acquaintances may not find it easy to share investment information with each other in a candid manner. For example, an investment sharing service provided by the financial institution of one investor may not be available to another investor who does not use that same financial institution. Therefore, current investment sharing systems do not allow for the convenient, transparent, and easily controlled sharing of investment information among socially acquainted individuals.

### SUMMARY

Investment information sharing applications, systems, and associated methods are disclosed that provide an individual a useful application to share verified investment information using a social networking website. Some embodiments of investment sharing applications can include a social networking module configured to communicate with the social networking website. Other embodiments can include associated APIs and integration methods offered by the social networking website, or screen scraping techniques. The social networking website can connect the user with at least one friend, and enable the user to select a selected friend with whom to share at least some investment information. The sharing of investment information need not be through the social networking website itself, but is enabled via the social networking website.

The investment sharing application can also include a financial institution access module configured to communicate with at least one financial institution website to collect investment information; an information selection module to allow the user to select sharable investment information to be shared with the selected individual, from among the investment information, and an information sharing module configured to provide the selected individual access via the social networking website to the sharable investment information. The software application can also be an application running within the social networking website.

In some embodiments, the sharable investment information can be made accessible directly through the social networking website, while in other embodiments the sharable investment information is made accessible in a manner other than directly through the social networking website, such as through API's, OFX requests, or screen scraping techniques.

In some embodiments the financial institution access module includes a database with access information for accessing the at least one financial institution via the internet. The access information can include a password and other access information. In some embodiments the investment information includes at least one of: identification of one or more individual investments; identification of the financial institution associated with each of the one or more individual investments; quantity held of each of the one or more individual investments; buy date and sell date for each of the one or more individual investments; share price for each of the one or more individual investment; and portfolio holding percentage of each of the one or more individual investments.

Similarly, the sharable investment information can include at least one of: identification of at least one investment; share price of each investment; performance information about each investment; buy date and sell date; and portfolio holding percentage of each investment. In some embodiments, the software application can indicate that at least one investment, and/or the performance of at least one investment is validated. Similarly, the information sharing module can allow comments related to a shared investment to be posted, for example on the social networking website, by a selected friend. In some embodiments, access to the sharable investment information can be in exchange for good consideration, such as a fee payment to the user, and/or a good and/or service provided to the user.

In some embodiments, a user's investment information can be shared through a social networking website by: logging onto a social networking website; collecting investment information from at least one financial institution website by a software application; selecting from the collected investment information sharable investment information to be published on the social networking website; and publishing the sharable investment information on the social networking website, the sharable investment information including identification of at least one investment, the sharable investment information being shared only with selected friends connected to the user and selected through the social networking website.

### BRIEF DESCRIPTION OF THE DRAWINGS

The following description can be better understood in light of Figures, in which:

FIG. 1 is a schematic drawing of a hardware system for an exemplary investment data sharing application and method;

FIG. 2 is an information flow-chart of an exemplary method of investment information sharing;

FIG. 3 is a flow-chart of an exemplary method of investment information sharing;

FIG. 4 is a flow-chart of an exemplary method of investment information sharing; and

FIG. 5 is a flow-chart of an exemplary method of investment information sharing.

Together with the following description, the Figures demonstrate and explain the principles of investment information sharing applications, systems, and methods for using and employing the investment information sharing applications and systems. In the Figures, the size, number and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that embodiments of investment information sharing applications and systems, and associated methods of using the applications and systems can be implemented and used without employing these specific details. Indeed, exemplary embodiments and associated methods can be placed into practice by modifying the illustrated units and associated methods and can be used in conjunction with any other devices and techniques conventionally used in the industry. For example, while the description below generally focuses on a embodiments for use with a social networking website with the basic features of Facebook®, the investment information sharing applications and systems, and associated methods could be equally applied with other social networking applications.

Social networking websites, like Facebook® and MySpace® provide online forums for individuals to discuss any topic with selected individuals, or with the general public. For example, Facebook® allows users to designate other users as “friends” and control the content shared with those friends. Many social networking websites also provide resources, such as Application Programming Interface (API), Facebook Markup Language (FBML), etc., for individuals to create applications that operate with the social networking website, allowing enhancement of the social networking experience.

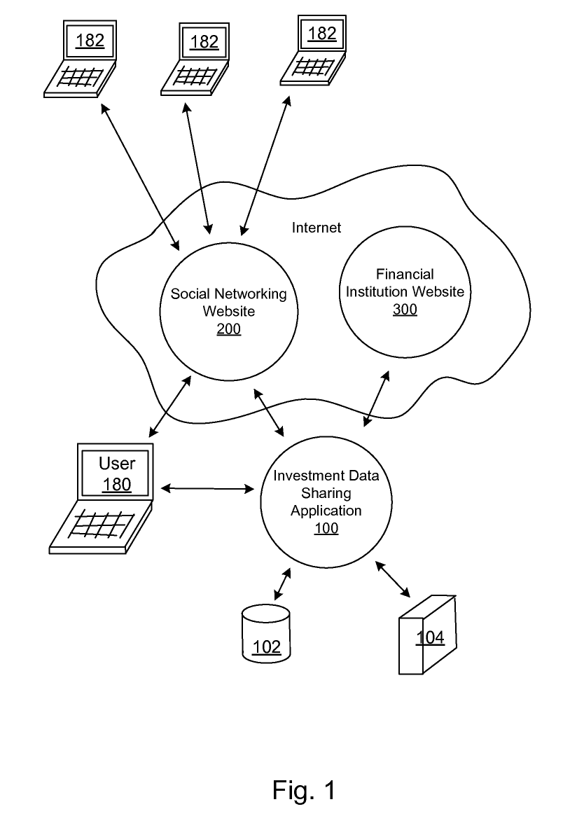

One exemplary system for use in sharing investment information (or investment data) using a social networking website is illustrated in FIG. 1. Investment data sharing application 100 may run on one or more computing devices, such as database 102, server 104, or that of a user 180. Investment data sharing application may also run on any computing device that can connect to the internet and is capable of running such applications. Investment data sharing application 100 may connect to social networking website 200 and financial institution website 300 through the internet. Friends 182 may connect to social networking website 200 to gain access to information provided by investment data sharing application 100, or to investment data sharing application 100 itself through the internet. An investment data sharing application can be implemented as one or more different software modules, each module working with the other modules to provide various embodiments of fantasy sports recommendation engines.

In some embodiments, an investment data sharing application can be present entirely on a single computer, such as a computer used by user 180. In other embodiments, an investment data sharing application can be a web-based application located on one or more of servers 104 and/or databases 102, or can be modules located on a combination of any of the components shown in FIG. 1. Of course, embodiments of investment data sharing applications according to the present invention can physically reside and operate in any configuration sufficient to provide the features and services as described below and illustrated.

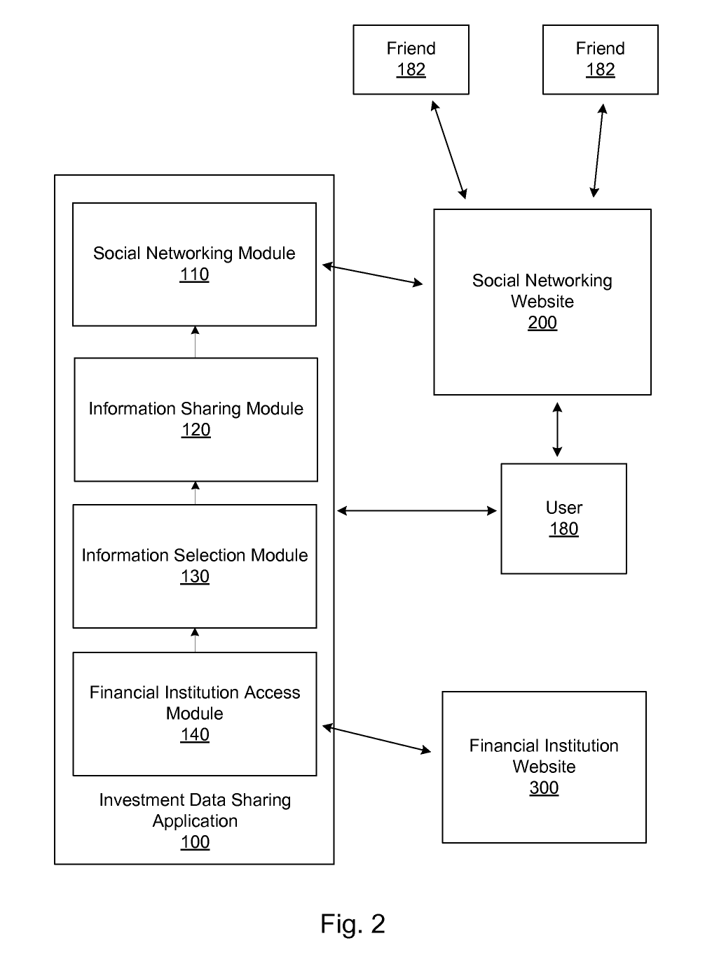

As shown in FIG. 2 embodiments of investment data sharing application 100 can include social networking module 110, information sharing module 120, information selection module 130 and financial institution access module 140. Social networking module 110 can interface with social networking website 200 to provide information exchange and management. Financial institution access module 140 can access financial institution website 300 to collect investment information for sharing on social networking website 200, or through investment data sharing application 100. Once investment information is retrieved from financial institution 300, information selection module 130 can allow user 180 to select information from the collected investment information that is to be shared. Information sharing module 120 can then provide access to the shared information for individuals, such as friends 182, selected by user 180 through social networking website 200.

Investment data sharing application 100 may be a Facebook® application created using development tools for Facebook®, such as FBML or other programming languages. Investment data sharing application 100 may also be compatible with other social networking websites. Investment data sharing application 100 may collect information from financial institution website 300 and social networking website 200 through APIs. For example, an API may be used to collect information from social networking website 200, such as friend lists and other user's information required before any information can be shared. Similarly, APIs, Open Financial Exchange (OFX) requests, or screen scraping techniques, can be used by investment data sharing application 100 to retrieve the investment information to be shared. Of course, any protocols, languages, or interfaces may be used to accomplish the functions of the various applications and methods described herein.

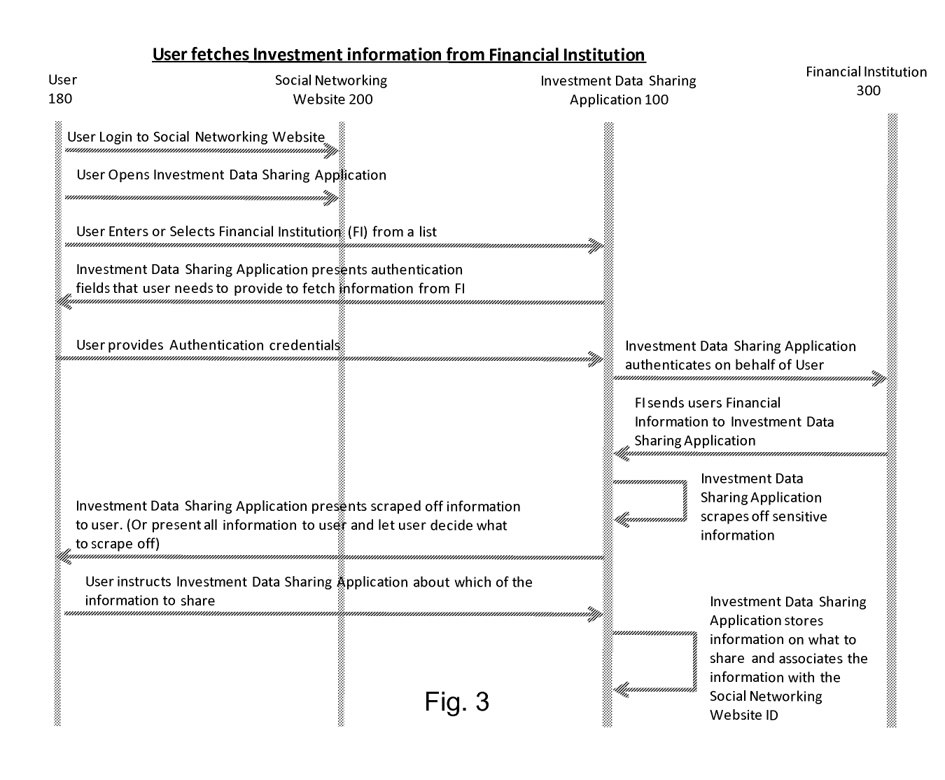

Turning now to FIG. 3, in some embodiments, user 180 can acquire investment information for sharing through social networking website 200 by first logging onto the social networking website 200. User 180 can then start investment data sharing application 100. User 180 can then be presented with a list of financial institutions 300. User 180 can select from the list a financial institution 300 with which user 180 has an account. If it is the first time user 180 has downloaded investment information from the particular financial institution, investment data sharing application 100 requests authentication information (such as password, username, account number, or other authentication tool) required by the financial institution to retrieve investment information for any individual investment or groups of investments held at the financial institution. Once user 180 provides the authentication information, investment sharing application can save the authentication information for automatic retrieval in subsequent sessions, or to allow user 180 to request investment information from the financial institution subsequently without needing to reenter the authentication information.

Once the investment information is received by investment data sharing application 100, the application can scrape off sensitive information, such a dollar amounts, total numbers of shares owned and traded, account numbers, personal information, etc. In some embodiments, user 180 may select from all investment information gathered from financial institution 300, which investment information to allow to be shared. Similarly, user 180 may set a preference for which information will be scraped off automatically by investment data sharing application 100, and which information will be shared. These preferences can be saved by investment data sharing application for later use.

The sharable investment information can be marked as verified by investment data sharing application 100 to signal to others viewing the shared investment information that it is genuine. Some information that can be shared may include buy and sell date of a particular investment, percent of total investment of any particular investment, current price per share, price per share at purchase, price per share at sale, and profit per share for the transaction. Other information such as ticker symbol, broker identification, etc., can also be shared, along with any available information desired by user 180. The shared investment information can then be posted to the social networking website for viewing by authorized friends 182 of user 180.

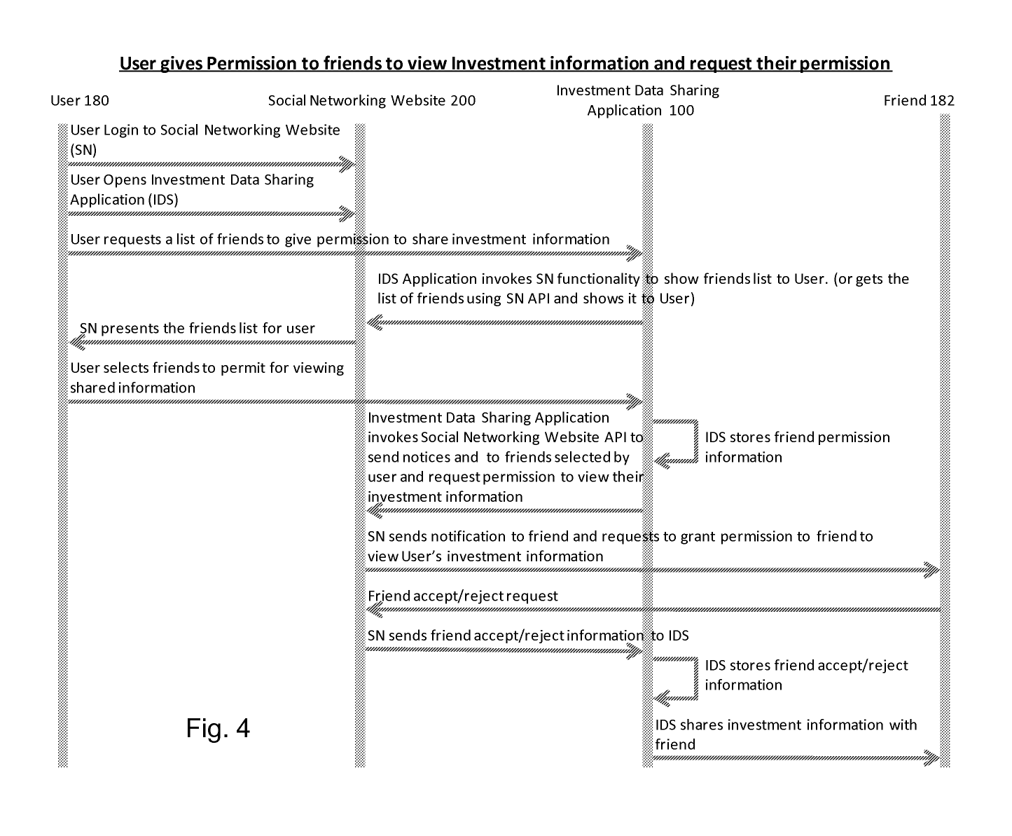

FIG. 4 illustrates a flow-diagram for authorizing friends to view sharable information. From within investment data sharing application 100, user 180 can request a list of friends from social networking website 200 (for example using API), and then selects friends to invite to view the sharable investment information. Investment data sharing application 100 may save the raw list and the selected list for subsequent invitation attempts to view the sharable investment information. The selected list can be sent to social networking website 200 to activate invitations to be sent to each friend on the selected list. Each selected friend can then accept or reject the invitation to view the sharable investment information. The acceptance or rejection information can then be sent back to investment data sharing application 100 to allow access to approved friends 182 to view the sharable investment information.

In some embodiments, the invitation to view the sharable investment information can include a price required to view the sharable investment information, or any other good consideration. Other possible consideration can be providing of a product or service, a barter exchange, or even recognition. For example, a user can stipulate that the friend to be provided with access to the investment information post the user's name, thereby providing recognition to the user, and indicating that the user was the source of investment information provided to the friend. Still other consideration will be readily apparent to one familiar with the everyday use of consideration in exchanges. When friend 182 accepts the invitation, friend 182 can then be presented with options for paying for access to view the sharable investment information. Once friend 182 pays, the payment information and authorization can be stored by investment data sharing application 100 to provide authentication for friend 182 to view sharable investment information, and to renew access, send renewal reminders, or notify friend 182 of changes in the availability or content of the sharable investment information. Payment and payment verification can be accomplished through any payment method available, such as Paypal®, credit cards, etc.

Once friend 182 is authorized to view sharable investment information, friend 182 may view the sharable investment information on the social networking website, or by accessing investment data sharing application 100. In some embodiments, friend 182 may also share investment information through investment data sharing application 100. In certain embodiments, a friend or user will need to log onto investment data sharing application 100 before seeing any sharable investment information from others. Similarly, a user may need to be logged on to investment data sharing application 100 before sharing their own investment information with others.

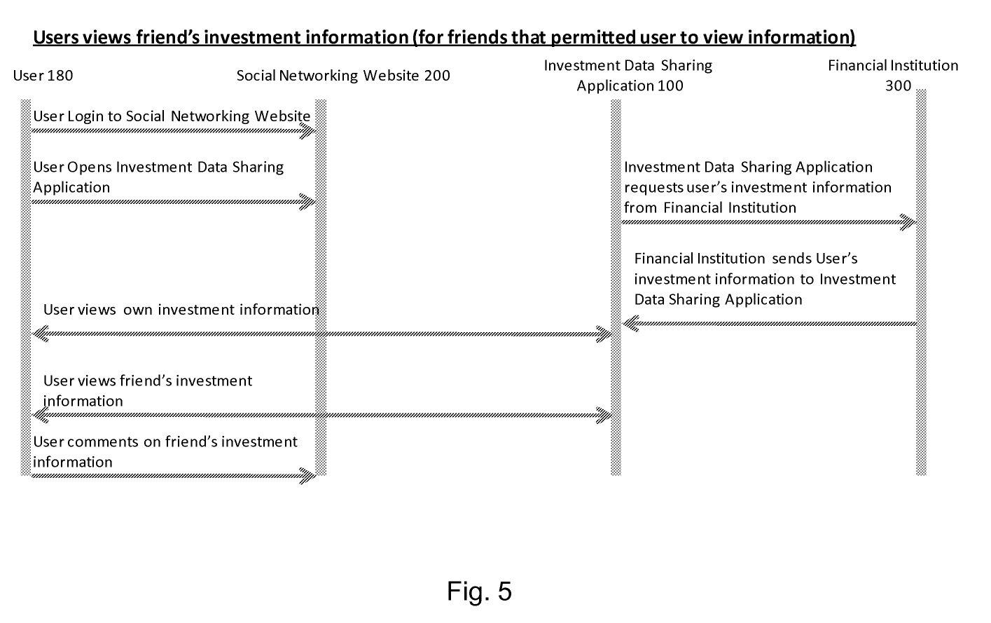

In some embodiments, such as is shown in FIG. 5, friends and user 180 may be able to comment on a particular shared investment, or on an overall investment portfolio or strategy shared through social networking website 200 or investment data sharing application 100. The comments may be available to be seen only by authorized friends, or may be visible to all without being able to see the underlying shared investment information to encourage others to become authorized to view the sharable investment information.

In addition to any previously indicated modification, numerous other variations and alternative arrangements can be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use can be made without departing from the principles and concepts set forth herein. Also, as used herein, examples are meant to be illustrative only and should not be construed to be limiting in any manner.

What is claimed is:

1. A software application for sharing at least some of a user's investment information with a selected friend of the user on a social networking website, the software application being configured to operate at least one computing device connected to the internet, and being configured to exchange information via the internet with other computing devices, the software application comprising:
a social networking module configured to communicate with the social networking website, the social networking website being capable of connecting the user with a friend of the user, and being capable of enabling the user to select a selected friend with whom to share at least some investment information;
a financial institution access module configured to communicate with at least one financial institution website to collect investment information;
an information selection module configured to allow the user to select sharable investment information from among the investment information, the sharable investment information to be shared with the selected friend; and
an information sharing module configured to provide the selected friend access to the sharable investment information, the access being provided using the social networking website.

2. The software application of claim 1, wherein the sharable investment information is made accessible directly through the social networking website.

3. The software application of claim 1, wherein the sharable investment information is made accessible in a manner other than directly through the social networking website.

4. The software application of claim 3, wherein made accessible through one of:
APIs;
Open Financial Exchange (OFX) requests; and
screen scraping techniques.

5. The software application of claim 1, wherein the financial institution access module includes a database with access information for accessing the at least one financial institution via the internet.

6. The software application of claim 2, wherein the access information includes a password.

7. The software application of claim 1, wherein the investment information includes at least one of:
identification of at least one individual investment;
identification of the financial institution associated with the at least one individual investment;
quantity held of the at least one individual investment;
buy date and sell date for the at least one individual investment;
share price for each of the at least one individual investment; and
portfolio holding percentage of the at least one individual investment.

8. The software application of claim 1, wherein the software application is configured to run within the social networking website.

9. The software application of claim 1, wherein the information sharable investment information includes at least one of:
identification of at least one investment;
price of each of the at least one investment;
performance information about the at least one investment;
buy date and sell date for the at least one investment; and
portfolio holding percentage the at least one investment.

10. The software application of claim 6, wherein validity of at least one of
the at least one investment, and
performance of the at least one investment
is marked as validated.

11. The software application of claim 6, wherein the information sharing module is further configured to allow at least one comment to be posted by the selected friend, the at least one comment being related to the at least one investment.

12. The software application of claim 8, wherein the at least one comment is posted on the social networking website.

13. The software application of claim 1, wherein the selected friend is granted access to the sharable investment information in exchange for good consideration.

14. The software application of claim 13, wherein the good consideration is one of:
a fee payment to the user;
a good provided to the user; and
a service provided to the user.

15. A method of sharing a user's investment information through a social networking website, the method comprising:
logging onto a social networking website, the social networking website connecting the user with friends;
collecting investment information from at least one financial institution website by a software application running on at least one computer connected to the internet;
selecting from the collected investment information sharable investment information to be published on the social networking website, the sharable investment information including identification of at least one investment; and
sharing the sharable investment information on the social networking website only with selected friends.

16. The method of claim 11, wherein the sharable investment information includes a percentage position for the at least one investment.

17. The method of claim 11, wherein the each of the selected friends is granted access to the sharable investment information in exchange for good consideration.

18. The software application of claim 13, wherein the good consideration is one of:
a fee payment to the user;
a good provided to the user; and
a service provided to the user.
